(19) United States
(12) Patent Application Publication
(10) Pub. No.: US 2017/0083486 A1
(43) Pub. Date: Mar. 23, 2017

(54) REGULATING UNDESIRABLE WEBPAGE CODE

(71) Applicant: Symantec Corporation, Mountain View, CA (US)

(72) Inventor: Timothy William van der Horst, Draper, UT (US)

(21) Appl. No.: 14/861,379

(22) Filed: Sep. 22, 2015

(51) Int. Cl. G06F 17/22; H04L 29/06; G06F 17/24

(52) U.S. Cl. CPC G06F 17/2247; G06F 17/24; H04L 63/20; H04L 63/0281

(57) ABSTRACT

In one embodiment, a device in a network intercepts webpage data sent by one or more servers for presentation in a browser application. The device identifies undesirable code in the intercepted webpage data based on one or more rules. The device modifies the webpage data to alter functionality of the undesirable code. The device provides the modified webpage data to the browser application.

### TECHNICAL FIELD

The present disclosure relates generally to computer networks and, more particularly, to systems and methods that regulate undesirable webpage code.

### BACKGROUND

While a large majority of webpages available on the Internet are harmless, some webpages contain code that may be considered malicious or otherwise undesirable by different entities. For example, certain webpages include code that is relatively innocuous, such as code that is used for purposes of advertising. In other cases, some webpages include code that can co-opt functions of the user's system.

Webpage scripting presents even greater challenges with respect to detecting undesirable webpage code. Notably, webpage scripting mechanisms, such as JavaScript and the like, can be used to conceal undesirable code and access greater functionality on the local client device. For example, a webpage script may be used to automatically launch pop-up windows, cause page redirections, load objects, etc. However, since these actions are often concealed within the code of the script, it remains challenging to detect undesirable webpage code before the code is executed.

Prior efforts to prevent the execution of undesirable webpage code have focused on either disabling scripting support at the browser level or outright blocking the webpage itself. For example, a network administrator may disable JavaScript support by default on users' computers and/or set up a firewall to block certain webpages from being accessed. However, such techniques take an all-or-nothing approach and may prevent a user from accessing a legitimate and business-necessary website.

### SUMMARY

According to embodiments herein, a device in a network intercepts webpage data sent by one or more servers for presentation in a browser application. The device identifies undesirable code in the intercepted webpage data based on one or more rules. The device modifies the webpage data to alter functionality of the undesirable code. The device provides the modified webpage data to the browser application.

In further embodiments, an apparatus is disclosed. The apparatus includes one or more network interfaces to communicate with a network. The apparatus also includes a processor coupled to the network interfaces and configured to execute one or more processes. The apparatus further includes a memory configured to store a process executable by the processor. When executed, the process is operable to intercept webpage data sent by one or more servers for presentation in a browser application. The process is also operable to identify undesirable code in the intercepted webpage data based on one or more rules. The process is further operable to modify the webpage data to alter functionality of the undesirable code. The process is also operable to provide the modified webpage data to the browser application.

In other embodiments, a tangible, non-transitory, computer-readable media having software encoded thereon is disclosed. When executed by a processor of a device, the software is operable to intercept webpage data sent by one or more servers for presentation in a browser application. The software is further operable to identify undesirable code in the intercepted webpage data based on one or more rules. The software is additionally operable to modify the webpage data to alter functionality of the undesirable code. The software is also operable to provide the modified webpage data to the browser

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example computing system, according to various embodiments.

FIG. 2 illustrates an example processing circuit, according to various embodiments.

FIG. 3 illustrates an example architecture for modifying webpage code, according to various embodiments.

FIGS. 4A-4B illustrate example containers being inserted into webpage code, according to various embodiments.

FIG. 5 illustrates an example environment modifier for webpage code, according to various embodiments.

FIGS. 6A-6B illustrate examples of webpage code being modified, according to various embodiments.

FIG. 7 illustrates an example simplified procedure for altering webpage code functionality, according to various embodiments.

In the figures, reference numbers refer to the same or equivalent parts of the present invention throughout the several figures of the drawing.

### DESCRIPTION OF EXAMPLE EMBODIMENTS

According to the techniques described herein, systems and methods are disclosed whereby webpage code may be intercepted prior to presentation by a browser application. In some aspects, the webpage code may be modified to alter the functionality of any code that is identified as being undesirable (e.g., to add additional webpage code, to the existing code, to directly alter the existing code, etc.), such as portions of a script that perform undesirable functions. The modified code may then be provided to the browser application. Thus, a user may still be able to access a large portion of the functionality of the webpage, while ensuring that the accessed webpage does not cause the user's device to perform unwanted/malicious actions.

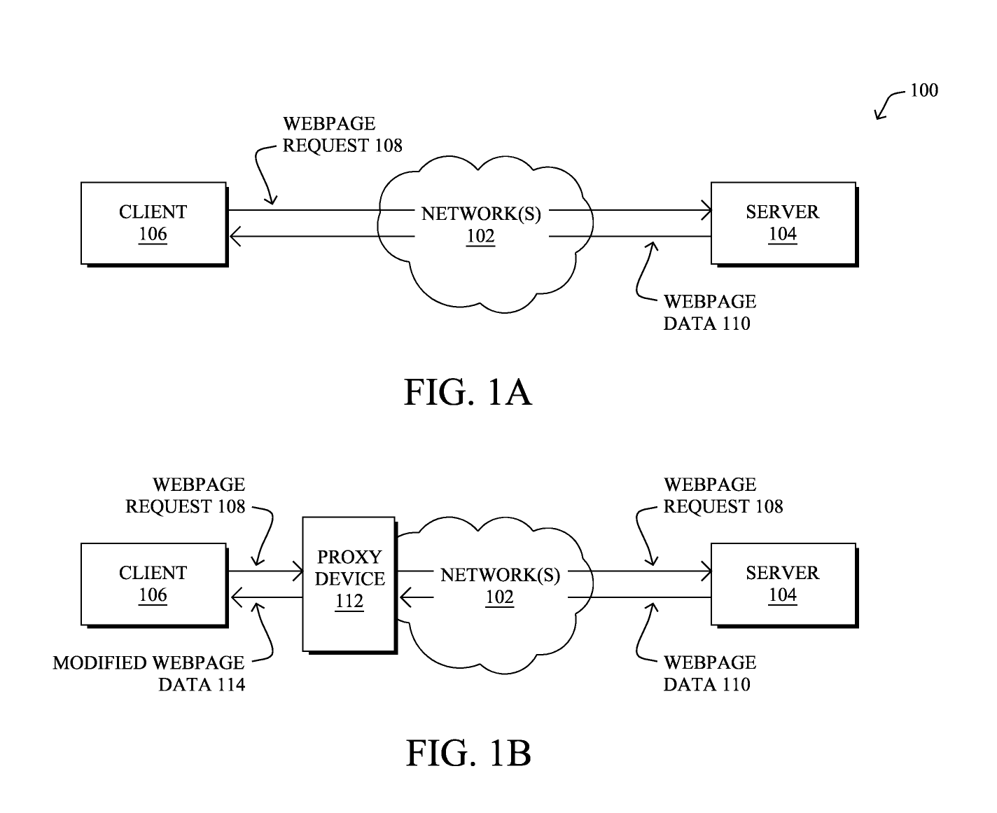

FIG. 1A illustrates an example computer system 100, according to various embodiments. As shown, a client device 106 may be in communication with a webpage server 104 via one or more computer networks 102. As will be appreciated, network(s) 102 may include, but are not limited to, local area networks (LANs), wide area networks (WANs), the Internet, cellular networks, infrared networks, satellite networks, or any other form of data network configured to convey data between computing devices.

Networks 102 may include any number of wired or wireless links between client device 106 and server 104. Example wired links may include, but are not limited to, fiber optic links, Ethernet-based links (e.g., Category 5/5e cabling, Category 6 cabling, etc.), digital subscriber line (DSL) links, coaxial links, T carrier links, E carrier links, combinations thereof, or the like. Example wireless links may include, but are not limited to, near field-based links, WiFi links, satellite links, cellular links, infrared links, combinations thereof, or the like.

Server 104 may be of any form of computing device operable to provide remote services to one or more client devices, such as client device 106. For example, server 104 may be a rack-based server, a desktop-based server, a blade server, or the like. In some embodiments, server 104 may be part of a data center in which multiple servers are hosted. In further embodiments, server 104 may be part of a cloud computing environment.

Client device 106 may be of any form of electronic device operable to communicate via network(s) 102. For example, client device 106 may be a desktop computer, a laptop computer, a tablet device, a smartphone, a wearable electronic device (e.g., a smart watch, a head up display, etc.), a smart television, a set-top device for a television, etc.

In general, client device 106 may be operable to receive webpage data and render the received webpage data on an electronic display. Notably, device 106 may execute a browser application that, when executed by device 106, is configured to request webpage data. In various embodiments, the browser application may be a stand-alone web browser or, alternatively, another form of application that is operable to render and display webpage data (e.g., a mobile application, etc.).

As shown, the browser application of client device 106 may send a webpage request 108 to server 104, to request certain webpage data. For example, the browser application may execute a HyperText Transfer Protocol (HTTP) GET command, to retrieve webpage data from server 104. Client device 106 may address request 108 to an Internet Protocol (IP) address or another form of network locator for server 104. In some cases, client device 106 may determine the address of server 104 by first performing a lookup of a Universal Resource Locator (URL), e.g., using a domain name system (DNS).

In response to receiving request 108, server 104 may retrieve the corresponding webpage data 110 and send webpage data 110 back to client device 106. As would be appreciated, webpage data 110 may include webpage code that the browser application of client device 106 may use to render the requested webpage. For example, webpage data 110 may include HyperText Markup Language (HTML) code, Extensible Markup Language (XML) code, or the like. In some embodiments, webpage data 110 may also include code written in a scripting language such as JavaScript or the like. Further, webpage data 110 may include, in some cases, multimedia files (e.g., images, video, audio, etc.) or other files to support the rendering of the webpage on client device 106.

Client device 106 may repeat the above process any number of times with any number of different servers, depending on the contents of webpage data 110. For example, if webpage data 110 includes an HTML image tag, client device 106 may send a separate request for the image to the location indicated by the tag. Similarly, webpage data 110 may cause client device 106 to request additional scripting files, multimedia files, HTML files, etc.

Referring now to FIG. 1B, computer system 100 may also include a proxy device 112, according to various embodiments. In general, proxy device 112 may be any intermediary device (e.g., router, firewall, stand-alone device, etc.) between client device 106 and server 104 in system 100. For example, in some embodiments, proxy device 112 may be associated with the gateway of the LAN in which client device 106 is located. In other embodiments, proxy device 112 may be another intermediary device located within network(s) 102 through which traffic associated with client device 106 flows.

As shown, webpage request 108 sent by client device 106 to server 104 may, in some cases, pass through proxy device 112 (e.g., either directly or rerouted to proxy device 112 for analysis). In turn, proxy device 112 may forward request 108 on to server 104. In response to receiving webpage request 108, server 104 may then send webpage data 110 back through proxy device 112 for display by the browser application of client device 106. In some embodiments, proxy device 112 may modify request 108 prior to sending the request to server 104, to cause server 104 to return webpage data 110 directly to proxy device 112. In other embodiments, proxy device 112 may be located in system 100 such that the returned webpage data 110 must pass through proxy device 112 before being delivered to client device 106.

In various embodiments, proxy device 112 may be configured to identify portions of the code of webpage data 110 that are undesirable, as defined by any number of rules or other configurable parameters stored by proxy device 112. As used herein, undesirable code may refer to any portion of webpage code that has the potential to cause a receiving device to perform an undesirable action. In other words, it is the format/form of the undesirable code that is considered to be undesirable, as certain forms of webpage code may be used for perfectly legitimate and desirable purposes. For example, proxy device 112 may identify any or all of the following categories of code as undesirable:
Obfuscation tools (e.g., eval, String.fromCharCode)
Document Object Model (DOM) modifications (e.g., document.write, appendChild, innerHTML)
Web Worker (JavaScript background threads)
AJAX (e.g., XMLHttpRequest)
Timing functions (e.g., setTimeout, setInterval)
Core structures (e.g., Object, Function)
Global helpers (e.g., navigator, open)

In further embodiments, any other form of webpage code may be identified as undesirable by proxy device 112, based on configurable rules/parameters maintained by proxy device 112. In some embodiments, proxy device 112 may also maintain any number of whitelists and/or blacklists that control whether proxy device 112 deems certain code as undesirable based on the source of the webpage code and/or on the destination client device for the webpage code (e.g., certain users may be allowed to access the full functionality of a particular webpage whereas others may not be allowed to do so).

In various embodiments, proxy device 112 may modify any code in webpage data 110 identified as undesirable and provide the modified webpage data 114 for presentation by the browser application of client device 106. In particular, proxy device 112 may modify the code of webpage data 110 according to any number of defined rules/parameters, to disable certain functionality of the code. For example, proxy device 112 may modify the scripting code within webpage data 110 to completely disable certain functionality (e.g., by commenting out certain portions of the code or otherwise deleting the portions of code). In other cases, proxy device 112 may modify the code to only allow the code to perform certain functions (e.g., by inserting programmatic wrappers around a scripting function, to prevent the wrapped function from performing certain actions).

While proxy device 112 is described primarily herein with respect to a separate device located between client device 106 and server 104 in system 100, other embodiments provide for the functionality of proxy device 112 to be implemented in a virtualized manner or directly on client device 106. For example, the webpage modification techniques described herein may be implemented as a stand-alone application on client device 106 or as a browser plug in for the browser application via which webpage data 110 is to be presented. In further embodiments, the functionality of proxy device 112 may be implemented across any number of devices as part of a cloud-based computing environment.

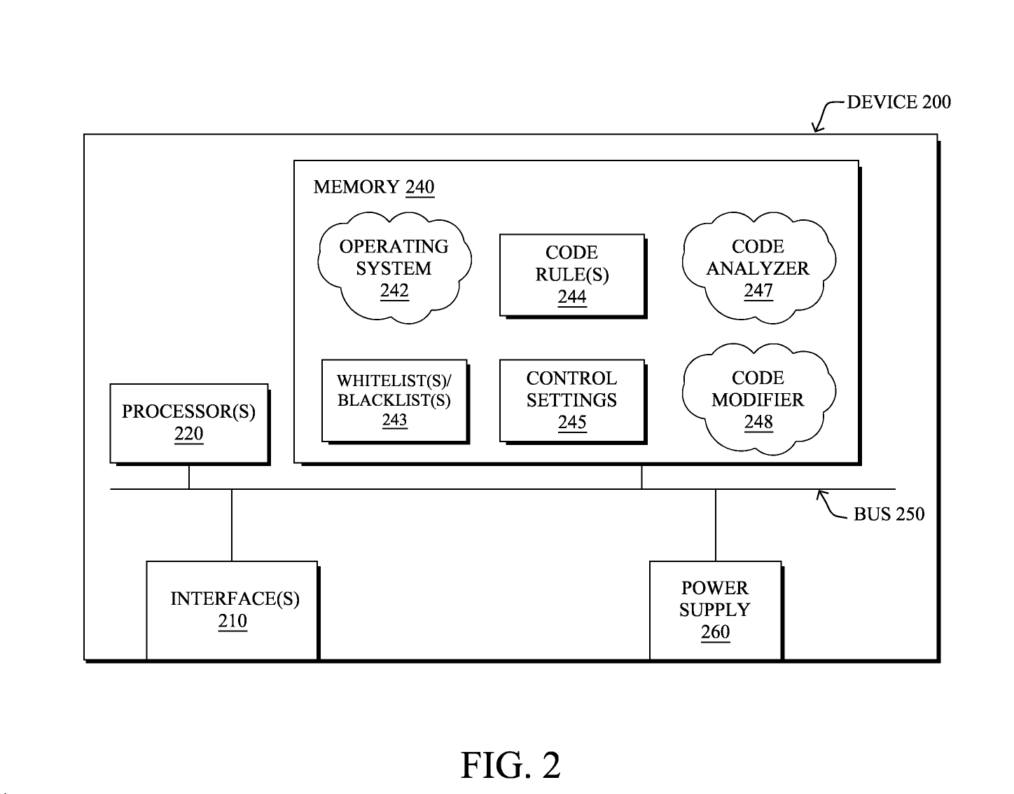

Referring now to FIG. 2, a schematic block diagram of an example processing circuit 200 that may be used with one or more embodiments described herein, e.g., as part of proxy device 112 or another device specifically configured to perform the page modifications described herein. As shown, processing circuit 200 may comprise one or more network interfaces 210 (e.g., wired, wireless, etc.), at least one processor 220, and a memory 240 interconnected by a system bus 250 and powered by a power supply 260.

The network interface(s) 210 contain the mechanical, electrical, and signaling circuitry for communicating data with other computing devices in system 100 (e.g., via network(s) 102. The network interfaces may be configured to transmit and/or receive data using a variety of different communication protocols. Note, further, that processing circuit 200 may have two different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 243-245. An operating system 242, portions of which are typically resident in memory 240 and executed by the processor, functionally organizes the device by, inter alia, invoking operations in support of software processes and/or services executing on the device. These software processes and/or services may comprise a code analyzer 247 and/or a code modifier 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

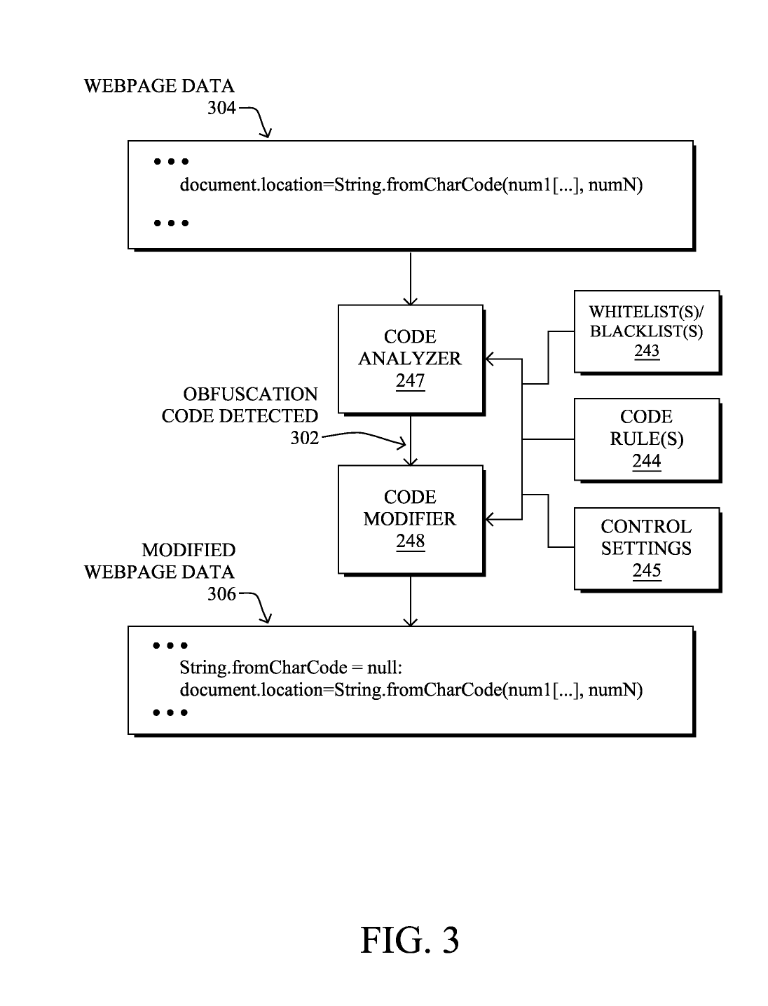

Referring now to FIG. 3, an example architecture for modifying webpage code is shown, according to various embodiments. As shown, assume that processing circuit 200 of proxy device 112 intercepts webpage data 304 sent by a webserver for presentation by a browser application of a client device.

In response to intercepting webpage data 304, code analyzer 247 may analyze the code in webpage data 304 (e.g., HTML code, scripting code, etc.), to identify any undesirable code within webpage data 304. Generally speaking, undesirable code refers to any webpage code that may cause the receiving device to perform operations that are expressly prohibited according to whitelist(s)/blacklist(s) 243, script rule(s) 244, and/or other control settings 245.

In some embodiments, whitelist(s)/blacklist(s) 243 may generally define sets of allowed or disallowed webpage functionality based on the sender and/or receiver of the corresponding webpage data. For example, while a business may generally wish to block certain webpage functions, certain “trusted” websites may be listed in a whitelist 243. Thus, when code analyzer 247 analyzes the intercepted webpage data, code analyzer 247 may determine that no modification of the trusted webpage code should be performed. Conversely, if the source of the webpage data is in a blacklist 243, webpage data 304 may be flagged by code analyzer 247 as requiring further analysis, to determine whether webpage data 304 includes any undesirable code.

In general, code rules 244 may include configurable rules that may be used by code analyzer 247 to identify undesirable code in webpage data 304 and by code modifier 248 to modify webpage data 304, if any undesirable code is detected by code analyzer 247. In some embodiments, code rules 244 may work in conjunction with whitelist(s)/blacklist(s) 243, to provide a more fine grained level of control over the modification of webpage data 304. For example, code rules 244 may include a rule that allows webpage data from a certain whitelisted website to still perform certain functionality, after the webpage data is modified. In other words, rather than disabling a certain portion of webpage code entirely, the rule may cause code modifier 248 to allow a method or function in the code to perform only certain operations and not others.

In some embodiments, control settings 245 may be used to further control the architecture shown. For example, in some embodiments, control settings 245 may cause code analyzer 247 and/or code modifier 248 to generate reporting data regarding any detected undesirable webpage code or modifications made thereto. In further embodiments, control settings 245 may include parameters that allow for a greater level of control over the functioning of the architecture shown. For example, control settings 245 may include parameters that allow for code rules 244 to be applied at the user level, user group level, or the like.

In one example of operation, assume that code rules 244 indicate that the String.fromCharCode(num1, . . . ,numN) Javascript method included in webpage data 304 is undesirable because it can be used to obfuscate the true location of a webpage document. Notably, this method can be used to convert a set of Unicode values into characters. In some cases, this method may be used maliciously to bypass filters that look only for a given URL or domain name that has been flagged as malicious. In other cases, the method may be used for completely legitimate reasons. However, since the true reason for using the method is often unknown until the method is evaluated, some entities may wish to block or otherwise change the functionality of the method, prior to execution by the destination client device.

Continuing the above example, code analyzer 247 may evaluate webpage data 304 and identify, or suspect the presence of, the String.fromCharCode method in webpage data 304 based on data in any or all of data structures 243-245. In response, code analyzer 247 may provide a notification 302 to code modifier 248 that indicates that obfuscation code was detected or suspected in webpage data 304. In further embodiments, indication 302 may also indicate any other portion of the code in webpage data 304 that are identified as undesirable, depending on the full code of webpage data 304 and the entries in data structures 243-245.

In response to receiving indication 302, code modifier may modify webpage 304 according to code rules 244, etc. For example, assume that an entry in code rules 244 stipulates that the functionality of obfuscation code in webpage data 304 should be blocked entirely. In such a case, code modifier 248 may disable this code, e.g., by deleting the undesirable code (as shown), commenting out the undesirable code, etc., in modified webpage data 306. In turn, modified webpage data 306 may be provided to the destination browser application for display.

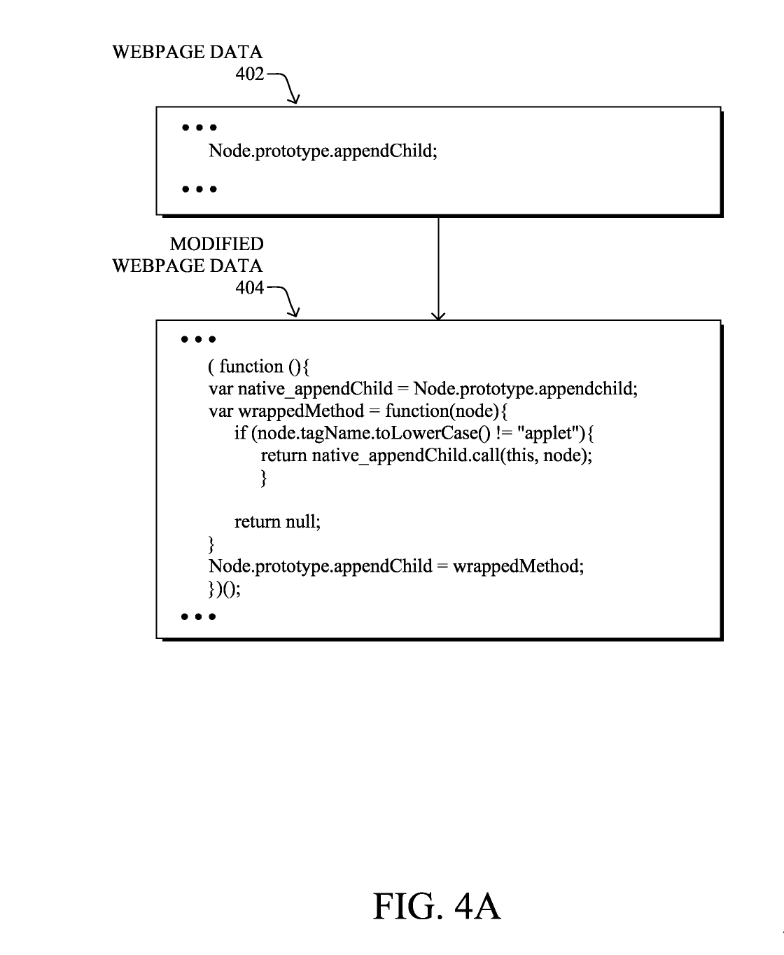

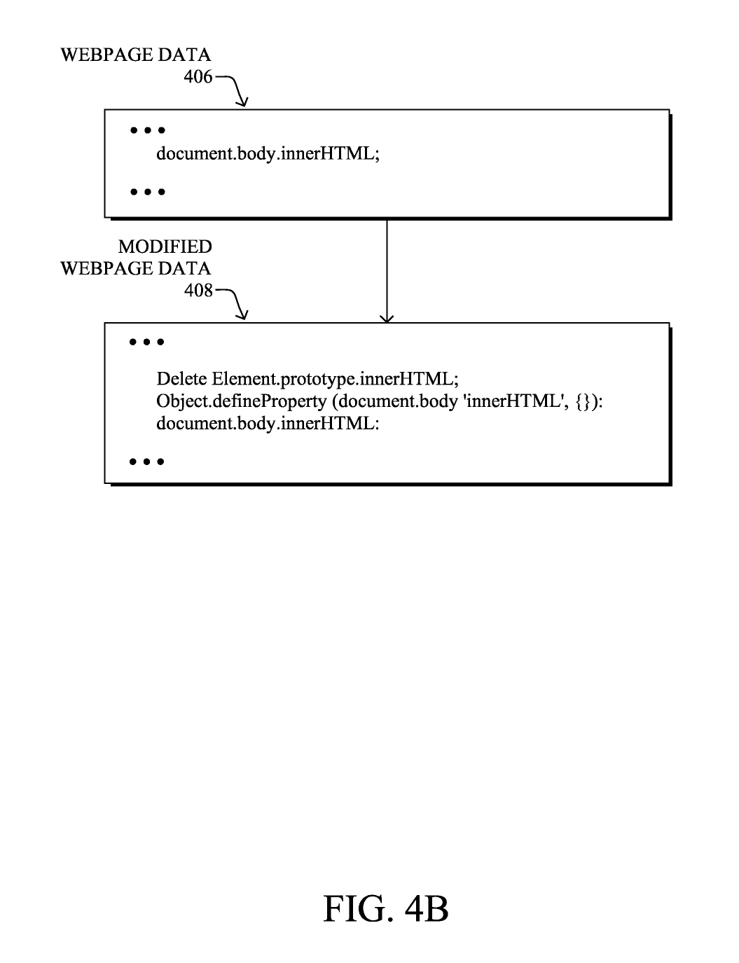

Referring now to FIGS. 4A-4B, further examples are shown of webpage code functionality being modified, according to various embodiments herein. In particular, FIGS. 4A-4B illustrate the use of programmatic containers to alter the functionality of a particular portion of webpage code that is deemed undesirable. Such containers may be additional code inserted into the webpage code that “wraps” the undesirable code. During execution, execution of the undesirable code must then be made via the wrapper code, allowing the wrapper code to control which functionality, if any, is allowed by the undesirable code.

As shown in FIG. 4A, assume that webpage data 402 received by processing circuit 200 includes the JavaScript method, appendChild( ), which is operable to modify the DOM of the webpage. Also, assume that such functionality is deemed undesirable, if left unrestricted. If processing circuit 200 identifies the method or otherwise suspects the presence of appendChild( ) in webpage data 402, processing circuit 200 may inject additional code into webpage data 402 that wraps the appendChild( ) in modified webpage data 404 by including the method within a function that is configured to selectively allow the method to be called. For example, as shown, the wrapper function in modified webpage data 404 may be operable to allow the DOM of the webpage to be modified, so long as an applet is not involved.

Referring now to FIG. 4B, assume that webpage data 406 received by processing circuit 200 includes the JavaScript code, innerHTML. Generally, this JavaScript property can be used to set or return the HTML contents of a DOM element. For example, this code can be used in some cases to insert new JavaScript into the code of webpage data 406. Thus, in some cases, processing circuit 200 may be configured to modify the functionality of this code, if processing circuit 200 detects the presence of innerHTML or otherwise suspects that this code is present in webpage data 406. For example, as shown, processing circuit 200 may use the Object.defineProperty( ) JavaScript method in modified webpage data 408, to disable the functionality of the innerHTML property. As would be appreciated, the location of innerHTML may differ across browser applications. For example, in certain versions of the Chrome™ browser, innerHTML may not be available via JavaScript prototypes. In such cases, processing circuit 200 may instead insert the following code into modified webpage code 408: Object.defineProperty(document.body, ‘innerHTML’, { }).

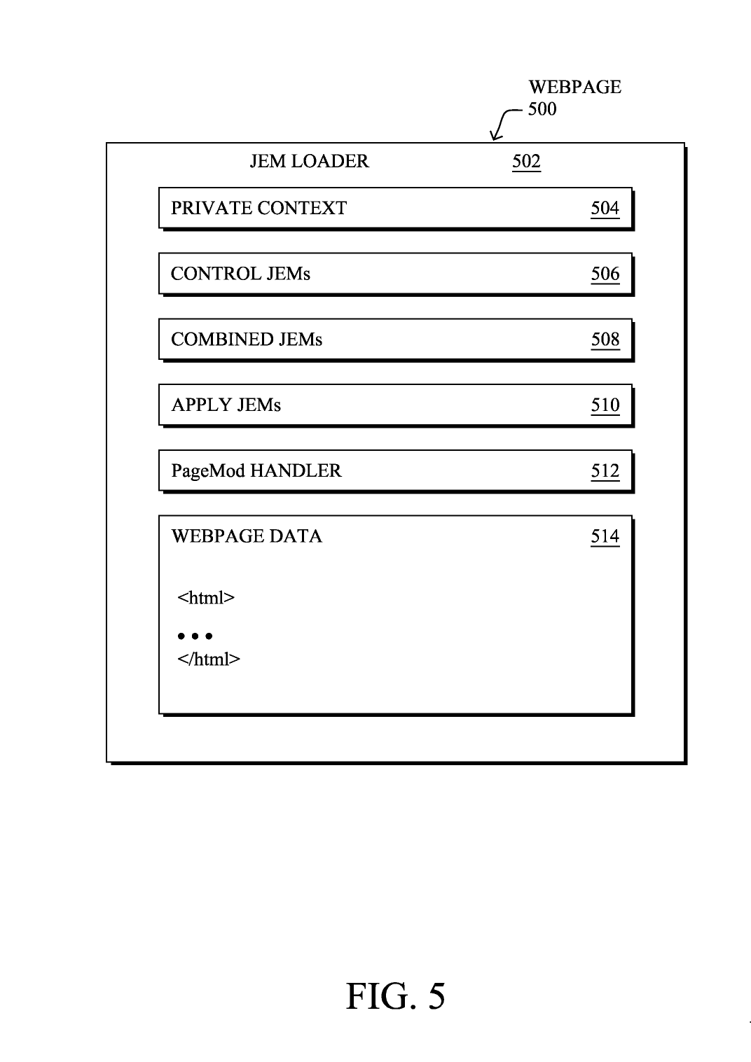

Referring now to FIG. 5, an example environment modifier for webpage code is shown, according to various embodiments. As described above, processing circuit 200 may be configured to apply code rules 244 on an individual basis (e.g., by identifying a particular portion of code and applying a wrapper to the code, etc.). However, doing so may be challenging to maintain the various rules and to manage code dependencies and relationships.

According to various embodiments, processing circuit 200 may be configured to use a common loader framework, to facilitate the modification of webpage code. As shown, consider webpage 500 that includes webpage data 514. In some embodiments, code modifier 248 may be operable to insert environment modifiers such as JavaScript Environment Modifiers (JEMs) into webpage 500, prior to webpage 500 being presented by the browser application. Notably, as shown, code modifier 248 may insert a JEM Loader 502 into the code of webpage 500. In general, JEM Loader 502 may provide a reusable skeleton for applying JEMs to different webpages, thereby allowing modification code to be reused and shared.

In some cases, JEM Loader 502 may include a private context 504 (e.g., using closure) that may include shared and/or local values. JEM Loader 502 may also include Control JEMs 506 (e.g., to control the functionality of webpage 500 dynamically), Combined JEMs 508, Apply JEMs 510, and/or a PageMod Handler 512 (e.g., to handle signals from special page modifications). Notably, JEMs 506-510 and PageMod Handler 512 may be operable to detect dynamically future scenarios in which the functionality of webpage 500 should be adjusted. For example, Control JEMs 506 may be operable to control how page modifications are made, based on the type of the executing browser application, version of the executing browser application, version of any installed plug-ins, or the like.

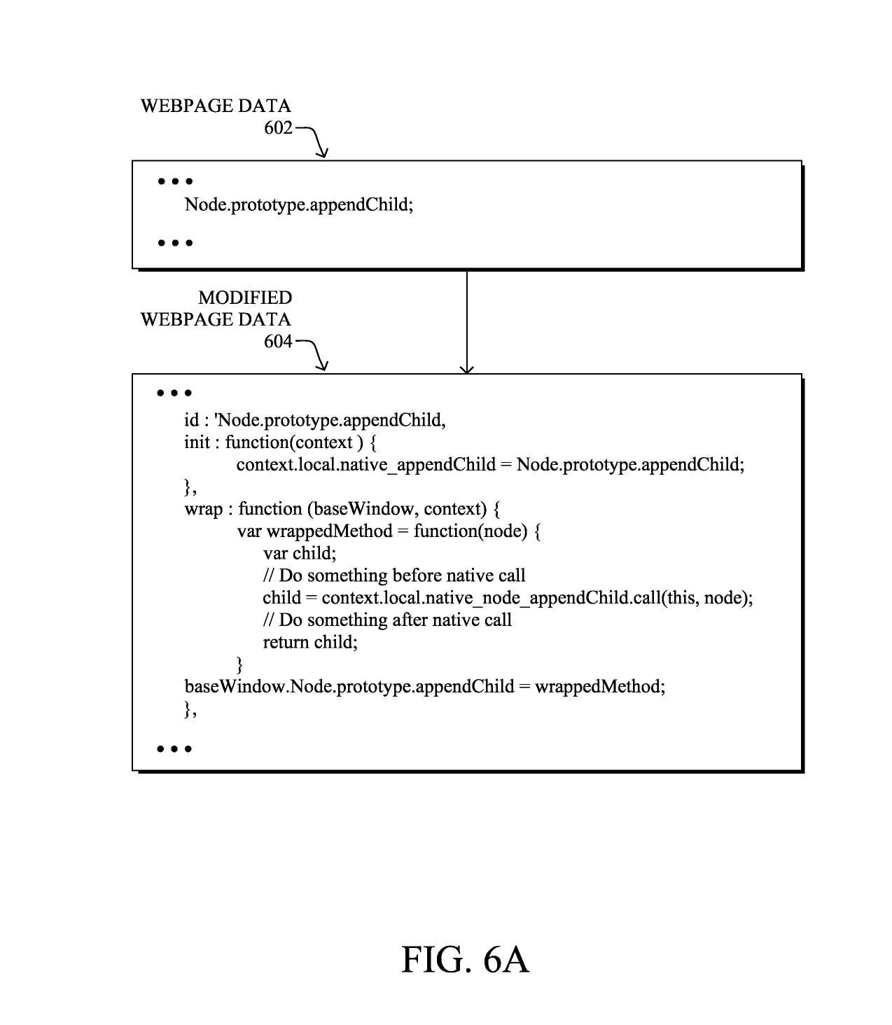

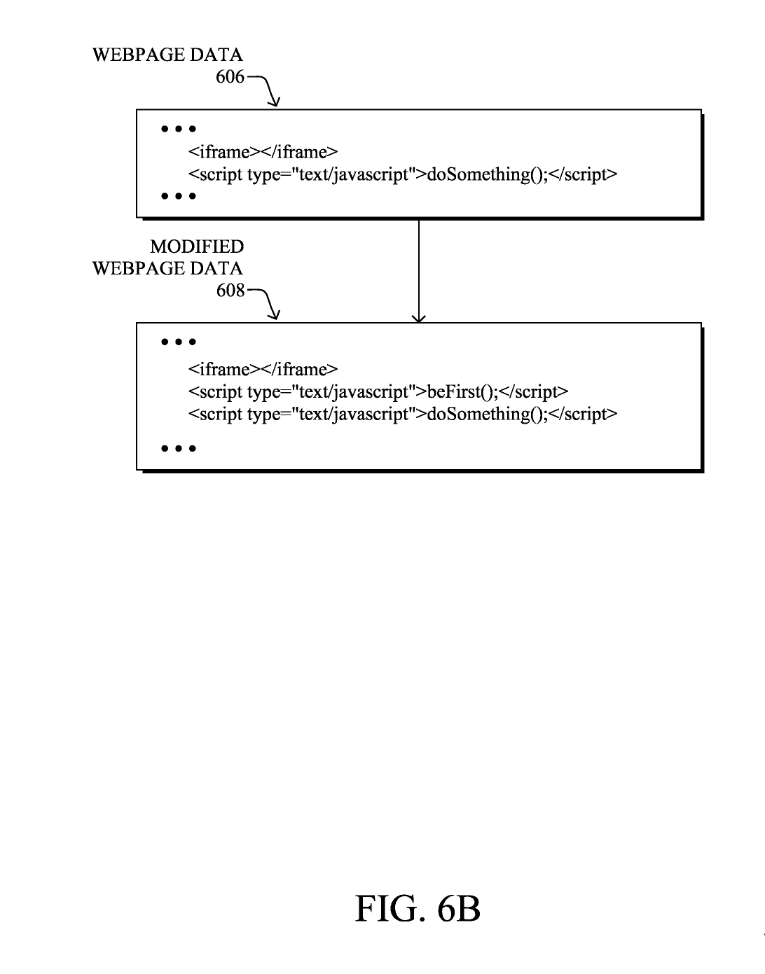

Referring now to FIGS. 6A-6B, examples of webpage code being modified are shown, according to various embodiments. As shown in the example of FIG. 6A, consider webpage data 602 that uses the appendChild JavaScript method, similar to the example shown in FIG. 4A. However, in the example shown in FIG. 6A, a JEM may be used to modify webpage data 602 into modified webpage data 604. In particular, the inserted JEM may wrap the appendChild method, allowing the original functionality of the method to be retained, if desired, while still allowing this functionality to be controlled, as needed.

In FIG. 6B, another example is shown with respect to iframes, according to some embodiments. As would be appreciated, invocation of an iframe causes a new copy of the window object to be allocated, since the iframe is intended to be a separate environment. Generally, iframes may be invoked either directly via HTML or via scripting code, such as JavaScript. However, the use of iframes also leads to the possibility of undesirable code having access to an unmodified window object.

In the example shown, assume that the method doSomething( ) in webpage data 606 is potentially risky, if allowed to execute first in the newly instantiated, unmodified iframe. In various embodiments, the doSomething( ) method may be wrapped such as another method, beFirst( ) wraps the window object before doSomething( ) can access the window object. Thus, beFirst( ) may be injected into modified webpage code 608, to ensure that beFirst( ) executes before doSomething( ). To prevent manipulation of beFirst( ), beFirst( ) may be defined as a property in JavaScript, as opposed to a function. In doing so, for example, the beFirst property may be set as non-configurable, thereby preventing undesirable code from overwriting beFirst and protecting a newly instantiated iframe.

As would be appreciated, the above examples are provided for illustrative purposes only and that any number of webpage modifications may be made, prior to presentation of the webpage by a browser application.

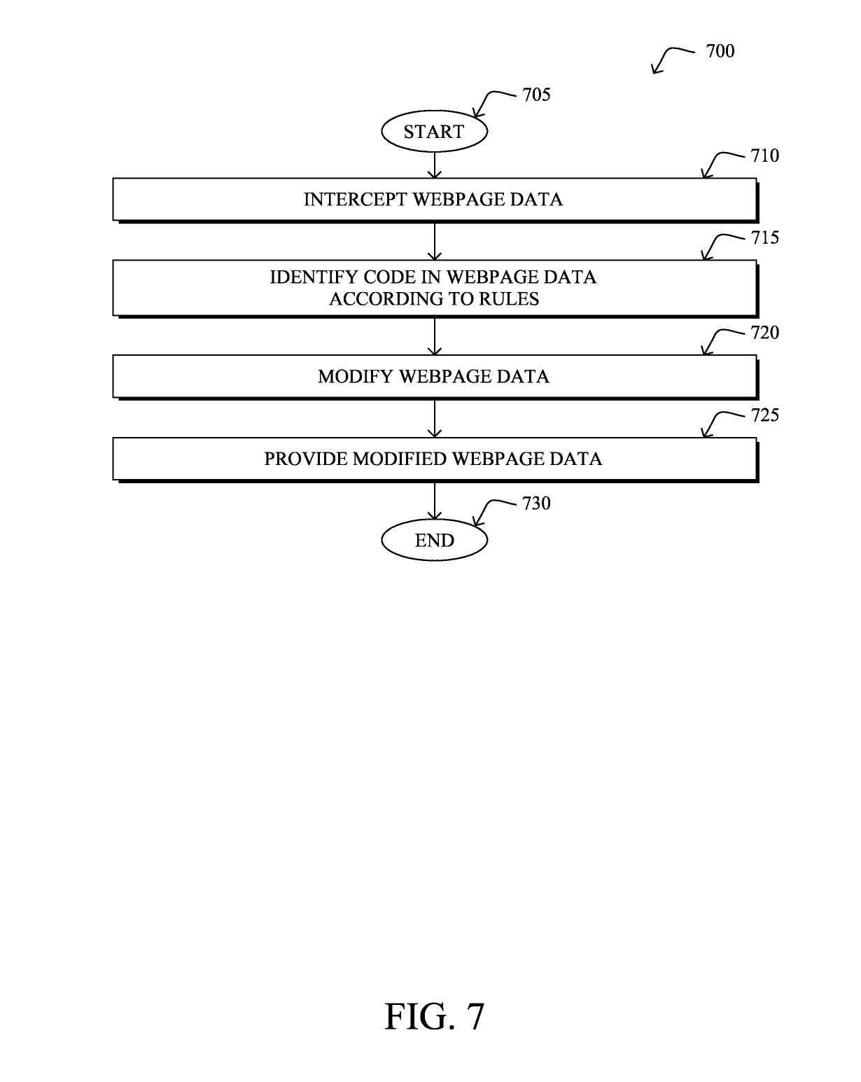

Referring now to FIG. 7, an example simplified procedure is shown for altering webpage code functionality, according to various embodiments. In general, procedure 700 may be performed by a processing circuit of a device (e.g., processing circuit 200) by executing stored instructions (e.g., processes 247-248). Procedure 700 begins at step 705 and continues on to step 710 where, as described in greater detail above, the device intercepts webpage data sent by one or more servers for presentation by a browser application. In some embodiments, the device may be a networking device through which the webpage traffic traverses in the network. For example, the device may be a proxy device located at the edge of a local network or elsewhere in the network between the servers and the client executing the browser application. In other embodiments, the device may be the client device itself. For example, a stand-alone application or a browser plugin may be operable to intercept the webpage data, prior to the browser application processing the webpage data.

At step 715, as described in greater detail above, the device may identify undesirable code in the webpage data based on one or more rules. Undesirable code may, for example, correspond to certain scripting functions, methods, properties, etc. that could be used for malicious or otherwise undesirable purposes (e.g., advertising, information collection, etc.). For example, the identified unwanted code may be a portion of a JavaScript or written using another scripting language (e.g., IronPython, document macros, etc.). Examples of undesirable code may include, but are not limited to, code that obfuscates execution of a function, code that modifies a document object model (DOM), code that executes a background thread, AJAX code, code that executes a timing function, or code that executes a global helper.

At step 720, the device may modify the webpage data to alter the functionality of the identified undesirable code, as described in greater detail above. In some embodiments, the device may simply disable all functionality of the code, such as by deleting the undesirable code or commenting out the undesirable code. In another embodiment, the device may insert a programmatic wrapper around the undesirable code. The wrapper may be operable to force any calls/executions of the undesirable code to be performed via the wrapper, thereby allowing the wrapper to control the functionality of the undesirable code (e.g., by preventing the undesirable code from performing certain actions).

According to various embodiments, steps 715 and 720 may be performed based on any number of configurable parameters/rules. For example, the device may maintain any number of whitelists and/or blacklists associated with the various webservers (e.g., a certain trusted website may be whitelisted, preventing modification of this website, etc.). Various levels of control may be implemented using these parameters. For example, the disallowed functionality for a website may be based on the source of the website, the client device receiving the webpage data, the local network hosting the client device, the particular user of the client device, or the like.

At step 725, the device may provide the modified webpage data to the browser application, as detailed above. For example, if the device is a proxy device, the proxy device may send the modified webpage data to the requesting client device for presentation in the browser application of the client device. In another example, if the webpage data is modified locally by the client device, the modified webpage data may be provided directly to the requesting browser application. Procedure 700 then ends at step 730.

It should be noted that while certain steps within procedure 700 may be optional as described above, the steps shown in FIG. 7 are merely examples for purposes of illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for modifications of the execution environment to be tuned to meet very specific criteria at a very granular level. This ability, when tied in with a reliable threat intelligence service, provides a network administrator with the ability to progressively restrict the ability of the client-side scripts or other webpage code to do harm, based on the perceived risk of the site/page being visited. As the perceived risk may fluctuate over time, the ability to apply modifications on-demand is very valuable.

As will be appreciated, the above examples are intended only for the understanding of certain aspects of the techniques herein and are not limiting in nature. While the techniques are described primarily with respect to a particular device or system, the disclosed processes may be executed by other devices according to further implementations. For example, while the techniques herein are described primarily with respect to webpages, the techniques herein are also applicable to the run-time modification of any content that includes a client-side evaluated script that passes through a proxy. This includes, but is not limited to, non-JavaScript scripting languages like IronPython, documents with embedded scripts like PDFs (which can include JavaScript), or possibly Office documents (e.g., embedded macros). In addition, the techniques herein may also be applicable to some types of client-side active browser content (e.g., Flash) which also rely on client-side evaluation of scripts. Another use for the techniques herein may also include email filtering. Notably, while most email clients disable scripts in emails by default, situations may exist where JavaScript is required and this could be used to mitigate the risk in those situations. In other words, the intermediary need not be restricted to a web-proxy, but may be another intermediary device, such as an email server.

In further embodiments, the techniques herein may also be adapted for purposes of passive reporting and intelligence using the programmatic wrappers described herein. Notably, while the wrappers may be operable to adjust the functionality of the undesirable code, in other cases, the wrappers may be operable to simply report on the undesirable code. Such information may be of value in a number of situations. For example, a website may be allowed to operate normally, but if the website begins to behave strangely an alert could be generated, or page execution terminated. In a broader sense, such reporting could also be used as part of a highly distributed intelligence gathering system to help quantify what ‘normal’ script behavior looks like.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
intercepting, by a device in a network, webpage data sent by one or more servers for presentation in a browser application;
identifying, by the device, undesirable code in the intercepted webpage data based on one or more rules;
modifying, by the device, the webpage data to alter functionality of the undesirable code; and
providing, by the device, the modified webpage data to the browser application.

2. The method as in claim 1, wherein the device comprises a proxy device located in the network between the one or more servers and a client device that executes the browser application.

3. The method as in claim 1, wherein the device comprises a client device that executes the browser application, and wherein the webpage data is intercepted by an application executed by the device, prior to presenting the webpage data in the browser application.

4. The method as in claim 1, wherein the undesirable code comprises JavaScript code.

5. The method as in claim 1, wherein modifying, by the device, the webpage data to alter functionality of the undesirable code comprises:
inserting a programmatic wrapper into the webpage data that limits functionality of the undesirable code.

6. The method as in claim 1, wherein modifying, by the device, the webpage data to alter functionality of the undesirable code comprises:
disabling the undesirable code in the webpage data.

7. The method as in claim 1, wherein modifying, by the device, the webpage data to alter functionality of the undesirable code comprises:
inserting a programmatic loader framework into the webpage data operable to alter the functionality of the undesirable code.

8. The method as in claim 1, wherein the webpage data is modified based on a whitelist or blacklist associated with the one or more servers.

9. The method as in claim 1, wherein the undesirable code comprises one or more of: code that obfuscates execution of a function, code that modifies a document object model (DOM), code that executes a background thread, AJAX code, code that executes a timing function, or code that executes a global helper.

10. An apparatus, comprising:
one or more network interfaces to communicate with a network;
a processor coupled to the network interfaces and configured to execute one or more processes; and
a memory configured to store a process executable by the processor, the process when executed operable to:
intercept webpage data sent by one or more servers for presentation in a browser application;
identify undesirable code in the intercepted webpage data based on one or more rules;
modify the webpage data to alter functionality of the undesirable code; and
provide the modified webpage data to the browser application.

11. The apparatus as in claim 10, wherein the device comprises a proxy device located in the network between the one or more servers and a client device that executes the browser application.

12. The apparatus as in claim 10, wherein the apparatus comprises a client device that executes the browser application, and wherein the webpage data is intercepted by an application executed by the apparatus, prior to presenting the webpage data in the browser application.

13. The apparatus as in claim 10, wherein the undesirable code comprises JavaScript code.

14. The apparatus as in claim 10, wherein the webpage data is modified by inserting a programmatic wrapper into the webpage data that limits functionality of the undesirable code.

15. The apparatus as in claim 10, wherein the webpage data is modified by disabling the undesirable code in the webpage data.

16. The apparatus as in claim 10, wherein the webpage data is modified by inserting a programmatic loader framework into the webpage data operable to alter the functionality of the undesirable code.

17. The apparatus as in claim 10, wherein the webpage data is modified based on a whitelist or blacklist associated with the one or more servers.

18. The apparatus as in claim 10, wherein the undesirable code comprises one or more of: code that obfuscates execution of a function, code that modifies a document object model (DOM), code that executes a background thread, AJAX code, code that executes a timing function, or code that executes a global helper.

19. A tangible, non-transitory, computer-readable media having software encoded thereon, the software when executed by a processor of a device is operable to:
intercept webpage data sent by one or more servers for presentation in a browser application;
identify undesirable code in the intercepted webpage data based on one or more rules;
modify the webpage data to alter functionality of the undesirable code; and
provide the modified webpage data to the browser application.

20. The tangible, non-transitory, computer readable media as in claim 19, wherein the device comprises a proxy device located in the network between the one or more servers and a client device that executes the browser application.
